(19) United States
(12) Patent Application Publication
(10) Pub. No.: US 2014/0144028 A1
(43) Pub. Date: May 29, 2014

(54) UTILITY KNIFE WITH PIVOTING HEAD ASSEMBLY

(71) Applicants: James GILBERT, Catlett, VA (US); Michael L. Marshall, Washington, DC (US)

(72) Inventors: James GILBERT, Catlett, VA (US); Michael L. Marshall, Washington, DC (US)

(21) Appl. No.: 14/157,187

(22) Filed: Jan. 16, 2014

Related U.S. Application Data
(63) Continuation-in-part of application No. 13/797,036, filed on Mar. 12, 2013.
(60) Provisional application No. 61/681,461, filed on Aug. 9, 2012.

(51) Int. Cl. B26B 1/02

(52) U.S. Cl. CPC B26B 1/02
USPC 30/321; 29/428

(57) ABSTRACT

A utility knife is provided that has an elongated main body portion and a head assembly that is separate from the main body portion. The main body portion has a handle assembly. A main body fastening mechanism is provided at one distal end of the handle assembly, and a handle assembly fastening mechanism is provided at one end of the handle assembly. A threaded pin pivotally fastens the main body portion to the head assembly by connecting the main body fastening mechanism to the handle assembly fastening mechanism. Accordingly, the head assembly can pivot with respect to the main body portion and handle assembly, so that the utility knife can be configured to cut an object at different angles, which can be particularly useful for the knife to fit in a tight cutting space.

### RELATED APPLICATIONS

This application is a continuation-in-part of Ser. No. 13/797,036, which claims the benefit of U.S. Provisional Application No. 61/681,461, filed Aug. 9, 2012, the entire contents of both of which are incorporated herein by reference.

### BACKGROUND OF THE INVENTION

1. Field of the Invention

The present invention relates to a utility knife. More particularly, the present invention relates to a utility knife that can pivot to enable use in different angles and/or to fit into tight spaces.

2. Background of the Related Art

Utility knifes are used for a variety of general or utility purposes. Utility knifes can have a number of features, including a retractable blade, replaceable blades, blade storage compartments, and breakaway blades. Most utility knifes are made of metal or rigid plastic. This makes the knife extremely durable and enables a large force to be applied to the knife by the user, resulting in a large cutting force. However, the knife is difficult to use in tight spaces, especially when a large cutting force is still needed. As a result, a right-handed user may be forced to use his/her left (weaker) hand to make a cut.

Carpet cutting is one illustrative, non-limiting utility knife application that requires a large cutting force. During installation, carpet needs to be cut accurately to match the wall, object, or other obstacle surface against which it is being laid. It is best to make the carpet cut as close to the obstacle itself, to ensure the best fit. However, the obstacles do not always allow for sufficient space to make a clean cut, and it can be difficult or impossible for the utility knife to fit in a tight space. In particular, obstacles having recessed bottom surfaces, such as furniture and cabinetry, which can present significant challenges to obtaining a proper carpet cut and can slow work. For instance, many cabinets have a toe kick that is recessed with respect to the rest of the cabinet.

As a result, the installer must cut at an angle or pull the carpet away from the tight space of the obstacle and estimate the distance to the obstacle. Consequently there is a need for a utility knife that is durable and can be used to impart a large cutting force, but at the same time is able to be used in tight spaces.

### SUMMARY OF THE INVENTION

Accordingly, it is an object of the invention to provide a durable utility knife that is extremely rigid in construction. It is a further object of the invention to provide a rigid, durable utility knife that can be easily utilized in tight spaces, such as at a cabinet toe kick or other surfaces that are difficult to reach. It is a further object of the invention to provide a durable utility knife that has a blade head assembly that can pivot transversely with respect to the knife handle body assembly.

A utility knife is provided that has an elongated main body portion and a head assembly that is separate from the main body portion. The main body portion has a handle assembly. A main body fastening mechanism is provided at one distal end of the handle assembly, and a handle assembly fastening mechanism is provided at one end of the handle assembly. A threaded pin pivotally fastens the main body portion to the head assembly by connecting the main body fastening mechanism to the handle assembly fastening mechanism. Accordingly, the head assembly can pivot with respect to the main body portion and handle assembly, so that the utility knife can be configured to fit in a tight cutting space.

These and other objects of the invention, as well as many of the intended advantages thereof, will become more readily apparent when reference is made to the following description, taken in conjunction with the accompanying drawings.

### BRIEF DESCRIPTION OF THE FIGURES

FIG. 1 is a perspective view the utility blade in accordance with the preferred embodiment of the invention;

FIG. 2 is a side exploded view of the utility blade of FIG. 1;

FIG. 3 is a top view showing the utility blade with the head in various pivoted positions;

FIG. 4 is a side view of one halve of the handle assembly having the fastening mechanism;

FIG. 5 is a side view of the other halve of the handle assembly;

FIG. 6 is one halve of the head assembly having a fastening mechanism; and,

FIG. 7 shows the utility knife for use in a tight space, such as under a cabinet toe kick or other objects that make it difficult to reach to cut.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose. Several preferred embodiments of the invention are described for illustrative purposes, it being understood that the invention may be embodied in other forms not specifically shown in the drawings.

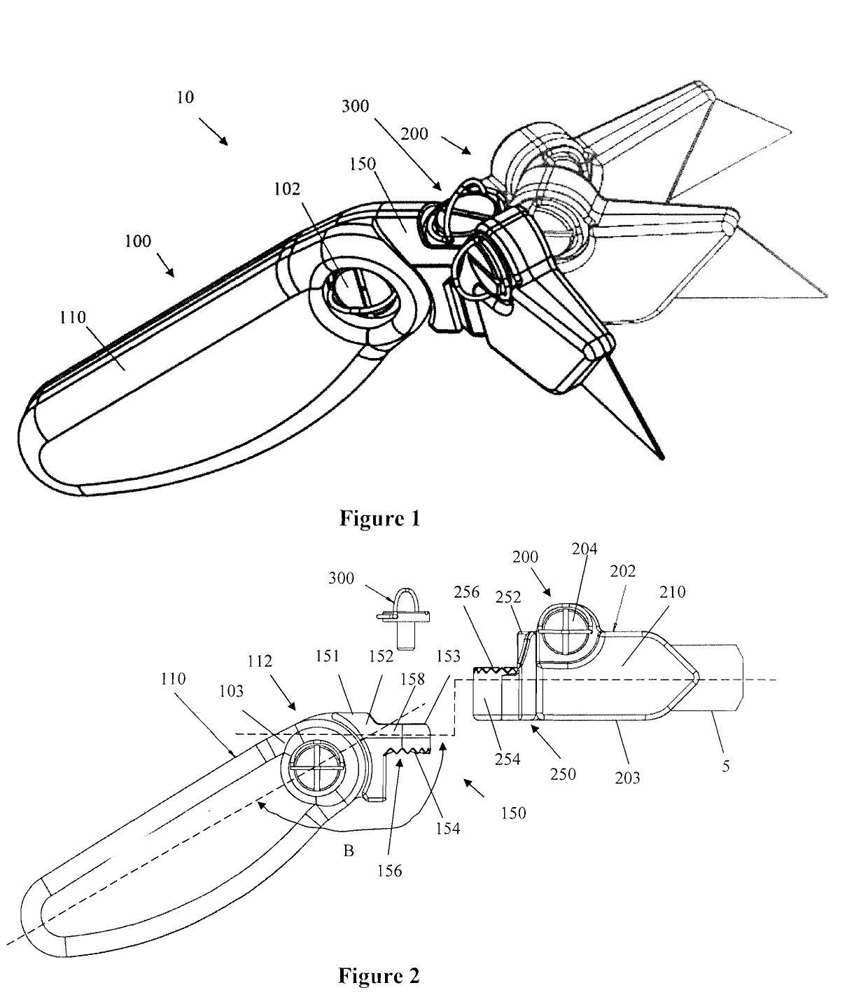

Referring to the drawings, FIG. 1 shows a box cutter or utility knife 10 in accordance with a non-limiting example of the preferred invention. The utility knife 10 has a main body 100 and a head assembly 200, which are pivotally connected together at a fastening mechanism 300. The main body 100 includes a handle assembly 110 that is elongated and has a longitudinal axis. The handle assembly 110 is configured to fit in the palm of the user's hand, and has a rectangular shape with rounded corners.

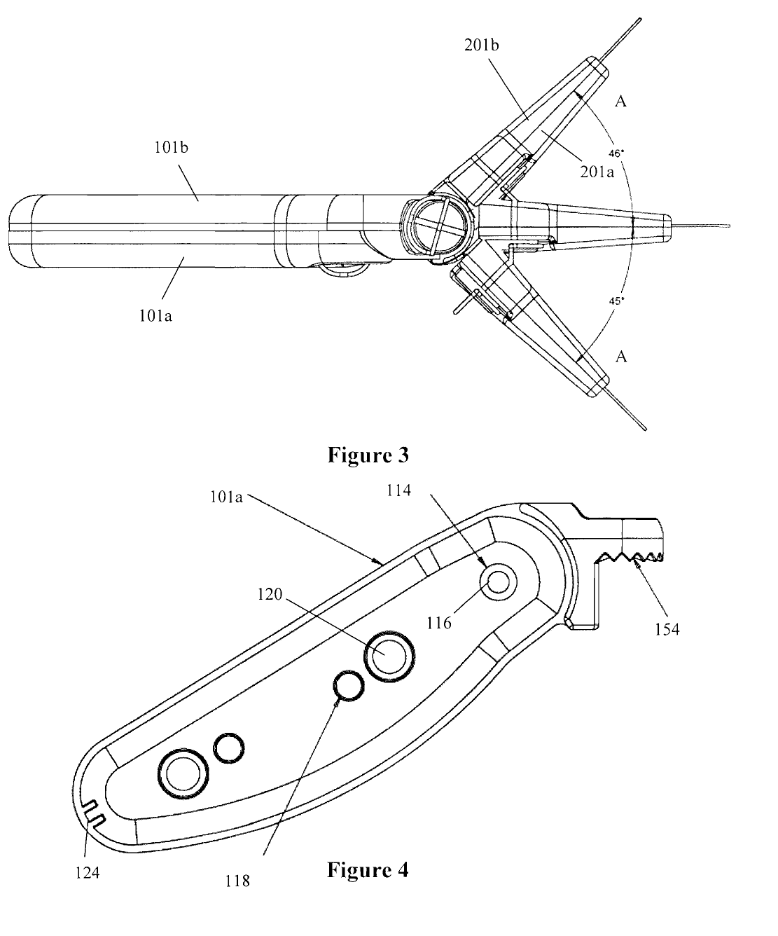

The handle assembly 110 has a first proximal end 112 and a second distal end opposite the first end 112. A neck or main body fastening portion 150 is formed integrally with the main body 100 at the proximal end 112 of the handle assembly 110. The main body fastening portion 150 has a support portion 152 that is connected to the proximal end 112 of the main body 110. A ledge 151 is formed at the top of the support portion 152. The ledge 151 is relatively flat and is contiguous with the top circumferential surface of the handle assembly 110, but at a radial angle thereto whereby the longitudinal axis (shown) of the body 210 is at an angle with respect to the longitudinal axis (shown) of the handle 110. That angle is best shown by angle B in FIG. 2, and is preferably about 135°-155° (when the body 210 is planar with the handle 110), and most preferably 145°, though any suitable angle can be provided. When viewed from the top (FIG. 3), the support portion 152 is linear with the handle assembly 110. However, when viewed from the side (FIG. 2), the ledge 151 of the support 152 is at an angle with respect to the top of the handle assembly 110 (as noted in the prior sentence, the angle is preferably about 135°-155°, though any suitable angle can be provided). Thus, the user can rest his/her thumb or forefinger on the ledge 151 during use of the utility knife 10, whereby the support ledge 151 provides extra leverage for the user to exert a cutting force and to control operation of the utility knife 10.

The main body fastening portion 150 also includes a circular-shaped fastening shelf 158 that extends outward from the support portion 152. The shelf 158 is slightly elongated and has a top surface 153, a bottom surface 154, and a longitudinal axis. The shelf 158 is positioned on the support 152 to be at an angle with respect to the handle assembly 110 (as noted above, the angle is preferably about 135°-155°, though any suitable angle can be provided). Thus, the top surface 153 and longitudinal axis of the shelf 158 are at a desired angle with respect to the longitudinal axis of the handle assembly 110 (as stated, preferably about 135°-155°, though any suitable angle can be provided). The top surface 153 of the shelf 158 is relatively flat and slightly lower than the flat top ledge 151 of the support 152. The top support ledge 151 and the top shelf surface 153 are substantially parallel to one another and together form the top or upper surface of the main body fastening portion 150.

The bottom surface 154 of the fastening shelf 158 is jagged to form triangular-shaped alignment teeth. A through-hole 156 is formed through the center of the circular shelf 158. substantially perpendicular to the longitudinal axis of the shelf 158 and the linear top surface 153.

Referring to FIGS. 3-5, the main body portion 100 is formed as first and second halves 101a, 101b that engage one another. The main body fastening portion 150 is integrally formed with a first one of the main body halves 101a. The second main body halve 101b has a threaded standoff 114 with a central through-hole 116 at the proximal end 112. The through-hole 116 receives the threaded lock nut 102 through an opening in the first main body halve 101a, which removably couples the main body halves 101a, 101b together. The lock nut 102 is seated in a recessed portion 103 that surrounds the head of the lock nut 102. The recessed portion 103 can be circular, as shown, though is preferably slightly larger than the screw head 102 and/or oblong to allow the user to reach under the screw 102 head and grab a lever that engages the screw 102 to tighten and loosen the screw 102.

Blade guide members 122 (FIG. 5) are provided at one of the halves 101b to retain the blades 5. One or more magnets 120 can be provided to magnetically retain a blade 5 positioned inside the second halve 101b for storage. Alignment features 118, such as posts, can be provided at the first halve 101a to receive elliptical openings in a carpet blade 5 so that the blades 5 are retained within the guides 122 for storage. Locking features 124 are located in a first half 101a that form a slot which receives a locking feature 126 in the second half 101b to ensure that the halves 101a, 101b are properly aligned when coupled together and prevent the distal end from coming free when the halves 101a, 101b are locked together.

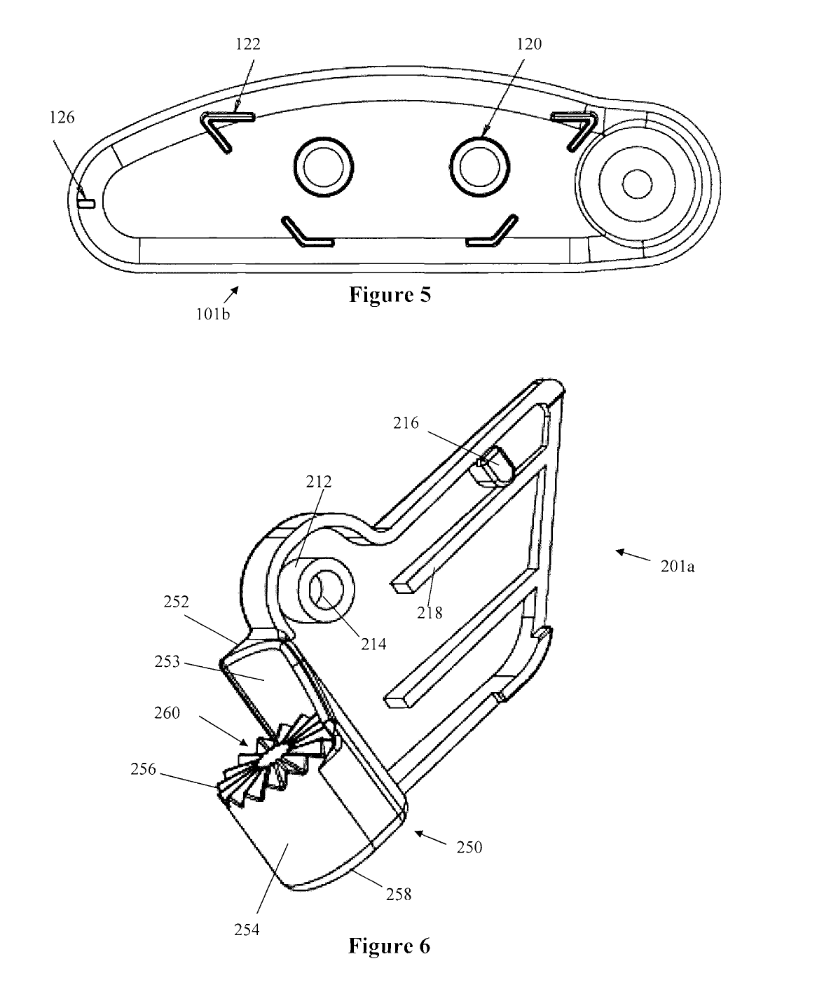

The head assembly 200 is an elongated member and relatively thin, so as to be sized and shaped to receive a utility blade 5. The head assembly 200 is formed by first and second halves 201a, 201b, as best shown in FIGS. 3, 6. The head assembly 200 can be, for instance, a carpet head assembly that houses and retains a carpet blade (as shown in FIG. 2) or a box head assembly that houses and retains a standard box blade (as shown in FIG. 1). The head assembly 200 includes a body 210 having a top 202 and a bottom 203.

As shown in FIG. 6, first head assembly halve 201a includes a threaded standoff 212 that has a through-hole 214 at the rear of the top end 202 of the body 210. The through-hole 214 receives a lock nut 204 (FIG. 2) that also passes through the second halve 201b to removably secure the two halves 201a, b of the head assembly 200 together. Thus, the lock nut 204 enables the head assembly halves 201a, b to be opened to gain access to the interior of the assembly 200. A worn blade 5 can thereby be removed and a new blade 5 inserted for use. The blade 5 rests against one or more elongated ridges 218 that support the blade 5. An alignment feature 216 couples with an alignment notch in the blade 5 to further retain the blade 5 in the proper position.

As further shown in FIG. 6, a head fastening portion 250 is integrally formed with the first halve 201a of the head assembly 200. The head fastening portion 250 includes a support 252 and a circular base member 254. The support 252 is integrally formed at the rear of the first head assembly halve 201a. The support 252 extends outward and has a curved inner surface 253 above the base 254. The base 254 has a flat bottom surface 258 and a top surface 256 formed as triangularly-shaped pivot alignment teeth. The base 254 also has a centrally-located threaded opening 260.

Referring back to FIG. 2, the main body fastening portion 150 and the head fastening portion 250 matingly engage one another to thereby pivotally couple the main body portion 100 with the head assembly 200 in a locked relationship. As shown, the shelf 158 of the main body fastening portion 150 and the base 254 of the head portion 250 extend outward toward each other from the main body 110 and the body 210 of the head assembly 200, respectively. The bottom surface 154 of the shelf 158 and the to surface 256 contain alignment teeth that engage one another, so that the head assembly 200 can be positioned at any one of a number of different angles with respect to the main body portion 100 and handle assembly 110. Three illustrative positions are shown, for instance, in FIGS. 1 and 3.

Thus, the head assembly 200 is coupled with the main body portion 100 by aligning the top surface 256 of the base 254 with the bottom surface 154 of the shelf 158. The inner surfaces of the supports 252, 152 are curved to match and receive the respective curved shelf 158 and base 254, respectively. The head assembly 200 is placed at a desired transverse angle with respect to the plane and longitudinal axis of the handle assembly 110. The main body portion 100 and head assembly 200 can then slide together.

Once the assemblies 100, 200 are in the desired position, the threaded locking pin 300 is then inserted to pass through the through-hole 156 of the shelf 158 and into the threaded opening 260 of the base member 254. The pin 300 can then threadably engage the base member 254 to lock the main body portion 100 and handle assembly 110 in the chosen position with respect to the head assembly 200. As noted above, the top surface 153 of the shelf 158 is slightly lower than the top support ledge 151, so that the lock nut 300 is relatively flush with the top of the support 152 when received in the through-hole 156. The user can then rest a finger or thumb on the locking pin 200 during use and to apply the cutting force. To change the angle, the threaded pin 300 can be loosened and the head assembly 200 pivoted, without fully removing the pin 300.

The entire utility knife 10 is formed of rigid material such as metal such as steel, aluminum, stainless steel, zinc, or other material such as plastic or polycarbonate plastic, including the main body 100, head assembly 200 and fastening portions 150, 250. The first and second main body portion halves 101a, b, are each formed as a single unitary and integral piece, including that the handle assembly 110 and the main body fastening portion 150 are formed as a single unitary and integral piece with the first main body halve 101a. And, the first and second head assembly halves 201a, b, are formed as a single unitary and integral piece, including that the head fastening portion 250 is formed as a single unitary and integral piece with the first head assembly halve 201a. Of course, the fastening portions 150, 250 can be separately formed and welded to the handle assembly 110 and body 210, respectively. Thus, the fastening portions 150, 250 are rigidly and permanently affixed to the main body 110 and head assembly 200, respectively. Accordingly, the utility knife 10 is a durable and rigid device that is capable of receiving a strong force for the user to apply a strong cutting force. The curved inner surfaces of the supports 152, 252 provide support to the shelf 158 and base 254 when pressure is applied by the user.

Thus, the fastener mechanisms 150, 250 and pin 300 cooperatively provide a pivot about which the head portion 120 can rotate in a transverse direction with respect to the main body 100. That is, from a side view (see arrows AA in FIG. 3), the head assembly 200 rotates to the left and right with respect to the main body 100. The main body 100 and head 200 have a larger width than depth. The wing nut 300 can be loosened, the head 200 positioned with respect to the main body 100, then the wing nut tightened to lock the head 200 into the desired position for use. The fastening portions can also be notched (as shown by the triangular-shaped teeth, so that the head 200 can be set at particular pre-defined positions with respect to the body 100, and the notches better retain the knife 10 in that set position. Further to the preferred embodiment, the head 200 can pivot up to approximately 45° in each direction, for a total swing of about 90°. Of course, any suitable amount of pivot can be provided, greater or less than 45°.

In the embodiments shown, the support 152 is provided at an angle with respect to the handle 110, so that the main body portion 100 has a bend that forms an angle (as noted above, the angle is preferably about 135°-155°, though any suitable angle can be provided). And, the head assembly 200 connects linearly with the support 250. Accordingly, the longitudinal axis of the handle 110 is at an angle with respect to the longitudinal axis of the support 150 and the head portion 200. However, other suitable embodiments can be provided, and the main body 110 need not be bent but can be linear (or planar) with the head portion 200.

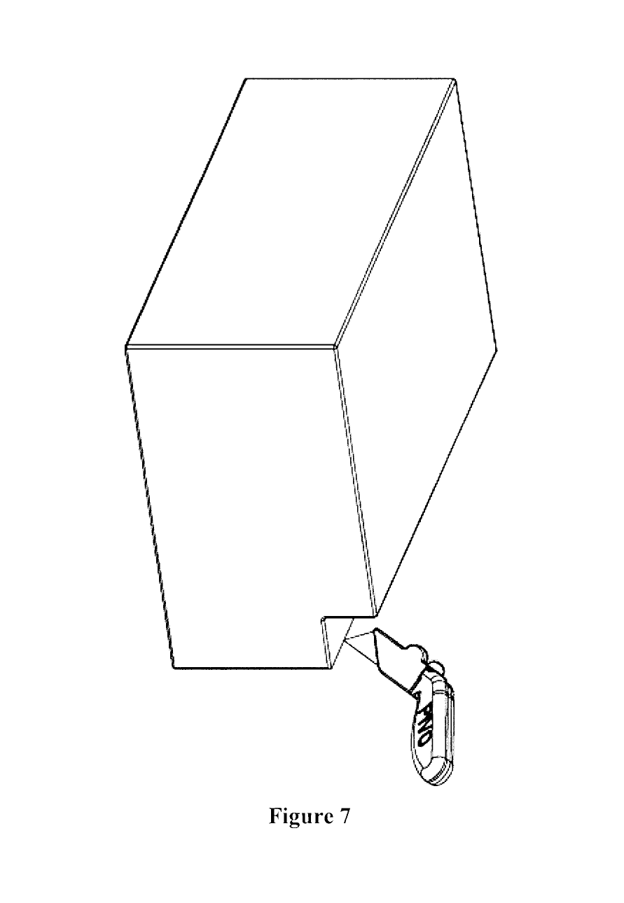

The head assembly 200 retains the utility blade 5. By pivoting the head assembly 200 with respect to the main body 100, it is easier for the user to reach into tight spaces, such as under a cabinet toe kick, as shown in FIG. 7. As shown, the knife can be angled to better fit under the cabinet toe kick. The knife enables the user to obtain a straight cut with the blade substantially at an orthogonal angle to the cutting surface rather than at an acute angle to the cutting surface. As shown in the figures, the blade body 100 and head portion 200 can be of any suitable type, such as ones that pivot to open up for replacement or storage of blades. Though the head assembly 200 is shown to secure the blade 5 in a fixed position, it should be appreciated that a retractable configuration can also be provided for the head assembly 200, so that the blade 5 can be retracted and extended from the head assembly 200.

The invention has been shown and described for use with a head assembly 200 that includes a utility blade or carpet blade. In another embodiment of the invention, the entire head assembly 200 can be removed from the main body portion 100 and replaced with a head assembly corresponding to any number of different types of tools. such as scrapers, chisels. tile grout grinder, etc.

As shown and described, the knife preferably pivots in a single dimension, i.e. from side-to-side (left to right; or transverse to the front surface of the main body 100 or the head portion 200) when viewed from the side (as during use). In other words, the head assembly 200 and the handle assembly 110 each have two opposing sides, a top and a bottom. The head assembly pivots in the direction that the head assembly sides are facing, toward one of the sides of the handle assembly. The user can push down on the knife without it creating a side-to-side force that pushes the head out of position. However, other suitable fastening mechanisms can be provided, such as allowing the head portion 200 to pivot or swing in other dimensions or directions with respect to the main body 100.

It is noted that the handle assembly 110 and the head assembly 200 have been shown and described as having two separate halves, and that the respective handle assembly fastening mechanism 150 and the head assembly fastening mechanism 250 are integrated with one of each of the halves. It should be recognized, however, that other suitable configurations can be provided. For instance, the main body portion 100 (including the handle assembly 110) can be a single closed unitary device that does not open, and the main body fastening mechanism 150 can be a single integral one-piece member. In addition, while the present invention allows for pivoting of the head assembly 200, the knife 10 can be provided with the head assembly 200 at a preset angle with respect to the handle assembly, that cannot be pivoted or adjusted.

As shown and described, a utility knife is provided with improved ergonomics to be able to cut an object at different angles. The knife is flexible to permit the user to maneuver the tool when cutting any surface. One example is cutting at an angle where a right handed person might otherwise have to use their left hand (weak hand) to reach the cutting area. The pivoting head of the present invention remedies this problem since the user can instead use their right hand (dominant hand) to make the necessary cut. It will be appreciated, however, that although the invention is especially useful in tight spaces, the invention is not limited to use in tight spaces.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A utility knife comprising:
a head portion configured to retain a blade;
a main body portion separate from the head portion; and
a fastening mechanism configured to pivotally connect said head portion to said main body portion.

2. The utility knife of claim 1, wherein said head portion can pivot about said fastening mechanism in a side-to-side direction with respect to the main body portion.

3. The utility knife of claim 1, further comprising a handle formed in at least a portion of said main body portion.

4. The utility knife of claim 1, wherein said fastening mechanism comprises a first fastening mechanism at said head portion and a second fastening mechanism at said main body portion, and wherein said first fastening mechanism is pivotally connected to said second fastening mechanism.

5. The utility knife of claim 4, wherein said first fastening mechanism has a first through-hole and said second fastening mechanism has a second through-hole, and further comprising a threaded pin extending through the first through-hole and threadably engaged with the second through-hole.

6. The utility knife of claim 4, wherein said first fastening mechanism has a bottom surface with first teeth and said second fastening mechanism has a top surface with second teeth, and said first teeth matingly engage said second teeth.

7. The utility knife of claim 1, wherein said head portion comprises first and second halves that define an interior, and further comprising a blade received at the interior of said head portion.

8. The utility knife of claim 7, further comprising a pin for removably coupling the first half to the second half.

9. The utility knife of claim 1, wherein said utility knife is made entirely of metal and is rigid.

10. The utility knife of claim 1, wherein said utility knife is hade of hardened steel.

11. The utility knife of claim 1, wherein said head portion has a central longitudinal axis and said main body portion has a central longitudinal axis, and wherein the central longitudinal axis of said head portion is at an angle with respect to the central longitudinal axis of said main body portion.

12. The utility knife of claim 11, wherein said angle is between 135°-155°.

13. The utility knife of claim 11, wherein said angle is 145°.

14. A method for forming a utility knife, comprising:
providing a head portion configured to retain a blade;
providing a main body portion separate from the head portion; and
pivotally connecting the head portion to the main body portion with a fastening mechanism.
